(19) United States
(12) Patent Application Publication
(10) Pub. No.: US 2017/0302444 A1
(43) Pub. Date: Oct. 19, 2017

(54) SYSTEM AND METHODS FOR KEYED COMMUNICATIONS CHANNEL ENCRYPTION AND DECRYPTION

(71) Applicant: Phillip H. Gillaspy, West Jordan, UT (US)

(72) Inventor: Phillip H. Gillaspy, West Jordan, UT (US)

(21) Appl. No.: 15/490,158

(22) Filed: Apr. 18, 2017

Related U.S. Application Data
(60) Provisional application No. 62/324,504, filed on Apr. 19, 2016.

(51) Int. Cl. H04L 9/06; H04L 9/08

(52) U.S. Cl. CPC H04L 9/0668; H04L 9/0816; H04L 9/0618; H04L 9/0643

(57) ABSTRACT

The present disclosure is directed to secure computations and transmission of encrypted data over a network. Two unequal unsigned integer numbers are used as keys, which are kept secret by users. Each key is supplied as the seed to a uniform pseudorandom number generator, and follows an algorithm to encrypt and decrypt a communications channel between two endpoints on the network. The communications channel is a stream of bits representing any data that may be represented or stored by a computer capable of processing binary data. In one illustrative embodiment, a network has multiple endpoints, such as different terminals disposed at different locations (for example, terminals at various branches of a financial institution that are connected to a common network). Using keys that are specific to transactions between specified terminals allows for greater security of the encrypted transmissions.

### CROSS-REFERENCE TO RELATED APPLICATION

This application claims the benefit of U.S. Provisional Application No. 62/324,504, filed Apr. 19, 2016, the disclosure of which is incorporated herein by reference in its entirety.

### BACKGROUND

Maintaining data confidentiality is an important concern for all computing device users regardless of task(s) performed. Encryption schemes represent one form of technology directed towards securing data when stored in memory and/or transmitted over networks. Many systems use a single encryption protocol for all communications over a network, regardless of the differences between various users. Should the encryption scheme be compromised, this could affect all communications over the network. One illustrative example of an encryption system is disclosed in U.S. Pat. No. 9,306,738, which issued Apr. 5, 2016 to Microsoft Technology Licensing, LLC, the disclosure of which is incorporated by reference herein in its entirety.

An encryption system or method that allowed for secure encryption between various endpoints on a network using a single protocol that could be followed by all endpoints and renders the deciphering by an unauthorized third party computationally impractical, would be an improvement in the art.

### SUMMARY

This summary is provided to introduce a selection of representative concepts in a simplified form that are further described below. This summary is not intended to identify key features or essential features of the claimed subject matter, nor is it intended to be used in any way that would limit the scope of the claimed subject matter.

The present disclosure is directed to secure computations and transmission of encrypted data over a network. Two unequal unsigned integer numbers are used as keys, which are kept secret by users. In some illustrative embodiments, each key is supplied as the seed to a uniform pseudorandom number generator, and follows an algorithm to encrypt and decrypt a communications channel between two endpoints on the network. In other illustrative embodiments, each key is supplied as the seed to a uniform pseudorandom eight-bit unsigned integer generator. The communications channel is a stream of bits representing any data that may be represented or stored by a computer capable of processing binary data. In one illustrative embodiment, a network has multiple endpoints, such as different terminals disposed at different locations (for example, terminals at various branches of a financial institution that are connected to a common network). Using keys that are specific to transactions between specified terminals allows for greater security of the encrypted transmissions.

### DESCRIPTION OF THE DRAWINGS

It will be appreciated by those of ordinary skill in the art that the various drawings are for illustrative purposes only. The nature of the present disclosure, as well as other embodiments in accordance with this disclosure, may be more clearly understood by reference to the following detailed description, to the appended claims, and to the several drawings.

FIG. 1A is an image of a simulation of a system in accordance with a first embodiment of the present disclosure being used to encrypt and decrypt a communication.

FIG. 1B is an image of a simulation of a system in accordance with a second embodiment of the present disclosure being used to encrypt and decrypt a communication.

FIG. 2 is a block diagram representing example non-limiting networked environments in which various embodiments described herein can be implemented.

FIG. 3 is a block diagram representing an example non-limiting computing system or operating environment in which one or more aspects of various embodiments described herein can be implemented.

### DETAILED DESCRIPTION

The present disclosure relates to apparatus, systems and methods for secure computations and transmission of encrypted data over a network. It will be appreciated by those skilled in the art that the embodiments herein described, while illustrative, are not intended to so limit this disclosure or the scope of the appended claims. Those skilled in the art will also understand that various combinations or modifications of the embodiments presented herein can be made without departing from the scope of this disclosure. All such alternate embodiments are within the scope of the present disclosure.

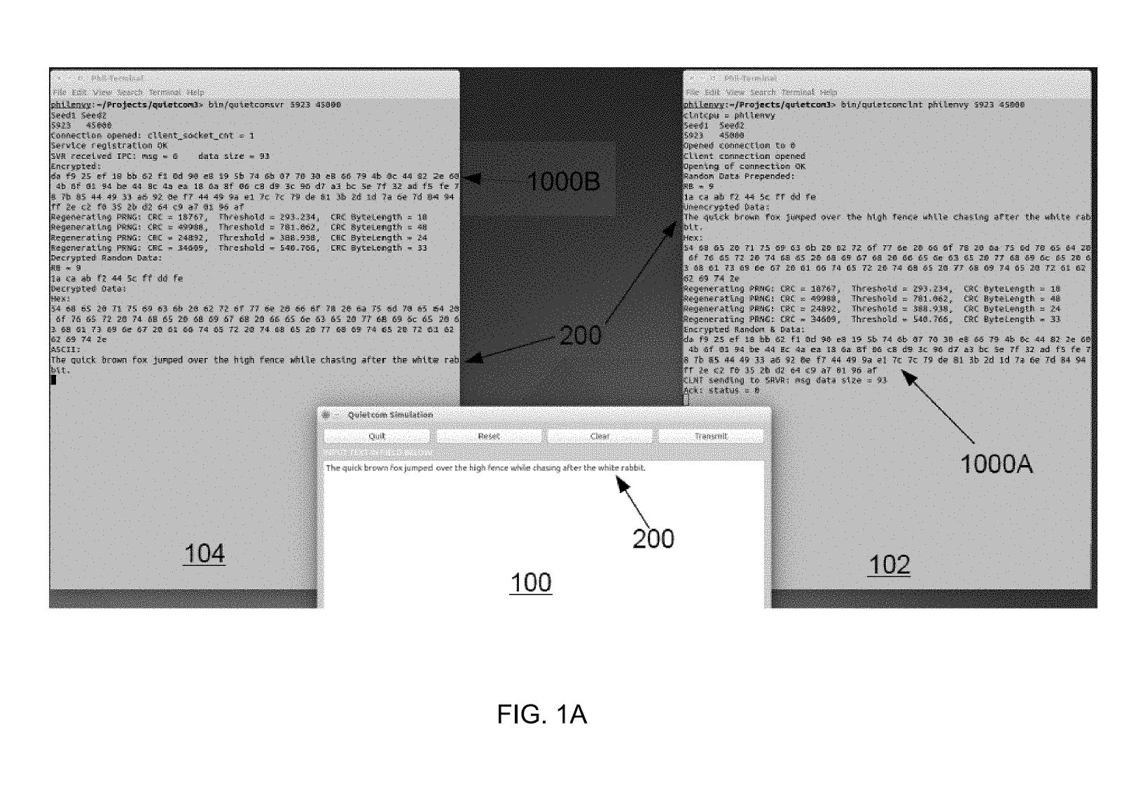

Turning to FIG. 1A, a first embodiment of a simulation of a system operating in accordance with the present disclosure is depicted. A communications window, shown at 100 depicts one example of a display that a user operating an endpoint of the system may view at a single endpoint when sending or receiving a communication 200. The operations conducted on the communication input at a first endpoint 102 are graphically depicted showing one example of an encryption calculation. Similarly, the operations conducted on the communication for output at a second endpoint 104 are graphically depicted showing one example of a decryption calculation.

In one illustrative embodiment, the system or method in accordance with this disclosure utilizes an algorithm that encrypts and decrypts a communications channel between two endpoints, such as those indicated at 102 and 104. The communications channel is a stream of bits representing any data that may be represented or stored by a computer capable of processing binary data. In the depicted example, the data comprises a length of ASCII text, which is converted to a hexadecimal string for encryption. It will be appreciated that this is merely illustrative and that any types of data files may be encrypted using the principles of the present disclosure.

In the depicted embodiment, the algorithm requires two keys, that is, unsigned integer numbers, designated as KeyA and KeyB. Both endpoints know both KeyA and KeyB. KeyA and KeyB must not be equal. Both KeyA and KeyB are kept secret.

In some embodiments, the various endpoints on a network may each have a particular set of keys for communicating with other specified endpoints on the network. For example, each endpoint could have a particular set of keys that are used only to communicate with a single other endpoint (or a subset of other endpoints). Then, even if the communication channel between two particular endpoints were compromised, others would not be.

Each key is a number supplied as the seed to a uniform pseudorandom real number generator. Thus, there are a number of uniform pseudorandom real number generators corresponding to the number of keys used. In this example, there are two keys and thus two pseudorandom real number generators used, although it will be appreciated that in other embodiments other numbers of keys and corresponding pseudorandom real number generators may be used. In the depicted embodiment of FIG. 1A, the keys are designated Seed1 and Seed2 and are 5923 and 45000, respectively.

For purposes of this description, one uniform pseudorandom real number generator will be referred to as the A-PRNG, and the other as B-PRNG. The uniform pseudorandom real number generators generate a number in the range [0.0,MAX]. The value of MAX can be any positive real number. MAX=10.0 is suggested as sufficient.

For purposes of this description, the algorithm will be described in the context of two endpoints communicating with each other, PNTA and PNTB. The algorithm description will refer to PRNG1 and PRNG2. PRNG1 and PRNG2 refer to either A-PRNG or B-PRNG as shown in Table 1 below.

TABLE 1

| Endpoint | Encryption | Decryption |
|---|---|---|
| PNTA | PRNG1 = A-PRNG seeded with KeyA | PRNG1 = B-PRNG seeded with KeyB |
| | PRNG2 = B-PRNG seeded with KeyB | PRNG2 = A-PRNG seeded with KeyA |
| PNTB | PRNG1 = A-PRNG seeded with KeyB | PRNG1 = B-PRNG seeded with KeyA |
| | PRNG2 = B-PRNG seeded with KeyA | PRNG2 = A-PRNG seeded with KeyB |

The length of KeyA and KeyB in bits is equal to 2K where K may be chosen as any integer greater than or equal to 4. The greater the value of K the greater the secureness of the encryption.

Two constant parameters are specified by the algorithm.

M=2^{(B-11)},

N=2^{(B-7)},

where B is the length of the cyclic redundancy check, CRC, in bits.

Three variable parameters are initialized as follows:
DevSumThreshold is assigned the value MAX/2*BITS, where BITS has a suggested value of 160,
CRCByteCount is assigned the value 8.
CRC is assigned the value of KeyB.

Associated with the CRCByteCount is a constant, CRCByteCntMax, whose suggested value is 64.

In the embodiment of FIG. 1A, the bit stream is encrypted as follows:
1) A random number is generated by PRNG1, R−A.
2) A random number is generated by PRNG2, D−B.
3) Calculate Deviation=R−A−D−B.
4) A running sum of the absolute value of the Deviation is maintained, DeviationSum.
5) A running sum of the number of bytes processed is maintained, ByteCnt.
6) If Deviation is greater than or to equal zero, then the next bit in the bit stream is inverted, otherwise it is not inverted. The resulting bit stream is the encrypted bit stream. In the depicted embodiment, this is designated at 1000A displayed at endpoint 102.
7) If DeviationSum is greater than DevSumThreshold, then the following processing is performed, otherwise step 8 is performed next.
   7a) A new CRC is computed from the last CRCByteCount number of bytes of the unencrypted bit stream. If the CRCByteCount is greater than ByteCnt, then the CRC is calculated from the last ByteCnt number of bytes of the unencrypted bit stream. The seed value for the new computed CRC is the current value of CRC.
   7b) The existing PRNG1 is destroyed, and a new PRNG1 is created using the CRC as the seed number.
   7c) DevSumThreshold is recomputed as the value of the CRC divided by M. If DevSumThreshold is less than MinThreshold, then DevSumThreshold is set to MinThreshold. Suggested value for MinThreshold is 100.0.
   7d) CRCByteCount is recomputed as the integer division of the value of the CRC divided by N. If CRCByteCount is less than or equal to zero, then CRCByteCount is set to 8. If CRCByteCount is greater than CRCByteCntMax, then CRCByteCount is set to CRCByteCntMax.
   7e) DeviationSum is reset to zero.
8) The algorithm is repeated from step 1 until all bits have been processed.

The encrypted data stream may then be transmitted to the receiving endpoint, such as depicted endpoint 104. In the depicted embodiment of FIG. 1A, this is shown at 1000B. The bit stream is then decrypted. In the depicted embodiment, this occurs as follows:
1) A random number is generated by PRNG1, R−A.
2) A random number is generated by PRNG2, D−B.
3) Calculate Deviation=R−A−D−B.
4) A running sum of the absolute value of the Deviation is maintained, DeviationSum.
5) A running sum of the number of bytes processed is maintained, ByteCnt.
6) If Deviation is greater than or to equal zero, then the next bit in the bit stream is inverted, otherwise it is not inverted. The resulting bit stream is the decrypted bit stream. The decrypted bit stream is identical to the original unencrypted bit stream, as shown at 200 in endpoint 104.
7) If DeviationSum is greater than DevSumThreshold, then the following processing is performed, otherwise step 8 is performed next.
   7a) A new CRC is computed from the last CRCByteCount number of bytes of the decrypted bit stream. If the CRCByteCount is greater than ByteCnt, then the CRC is calculated from the last ByteCnt number of bytes of the decrypted bit stream. The seed value for the new computed CRC is the current value of CRC.
   7b) The existing PRNG1 is destroyed and a new PRNG1 is created using the CRC as the seed number.
   7c) DevSumThreshold is recomputed as the value of the CRC divided by M. If DevSumThreshold is less than MinThreshold, then DevSumThreshold is set to MinThreshold. Suggested value for MinThreshold is 100.0.
   7d) CRCByteCount is recomputed as the integer division of the value of the CRC divided by N. If CRCByteCount is less than or equal to zero, then CRCByteCount is set to 8. If CRCByteCount is greater than CRCByteCntMax, then CRCByteCount is set to CRCByteCntMax.
   7e) DeviationSum is reset to zero.
8) The algorithm is repeated from step 1 until all bits have been processed.

Optionally, RB number of random bytes may be inserted into the bit stream preceding the beginning of the true unencrypted data. RB may be generated from a uniform pseudorandom integer number generator using the absolute value of (KeyA−KeyB) as the seed and generating a random number in the range [0,255]. The intent of prepending RB random bytes is to mask the values of KeyA and KeyB to someone attacking the beginning of the transmission wherein the transmission of the true encrypted data would otherwise always start with KeyA and KeyB. In the depicted embodiment of FIG. 1A, RB is 9.

Turning to FIG. 1B, a second embodiment of a simulation of a system operating in accordance with the present disclosure is depicted, using like reference numerals to FIG. 1A for like elements. A communications window, shown at 100 depicts one example of a display that a user operating an endpoint of the system may view at a single endpoint when sending or receiving a communication 200. The operations conducted on the communication input at a first endpoint 102 are graphically depicted showing one example of an encryption calculation. Similarly, the operations conducted on the communication for output at a second endpoint 104 are graphically depicted showing one example of a decryption calculation.

Each key is a bit string supplied as the seed to an eight-bit unsigned integer uniform pseudorandom number generator. Thus, there are a number of eight-bit unsigned integer uniform pseudorandom number generators corresponding to the number of keys used. In this example, there are two keys and thus two eight-bit unsigned integer pseudorandom number generators used, although it will be appreciated that in other embodiments other numbers of keys and corresponding eight-bit unsigned integer pseudorandom number generators may be used. In the depicted embodiment of FIG. 1B, the keys are designated KeyA and KeyB and are “490mv0Q” and “BM19fRT”, respectively. KeyA and KeyB are bit strings, or equivalently, a number of bit length 2^{L}. The lengths of KeyA and KeyB in bits are equal to 2^{L} where L may be chosen as any integer greater than or equal to 4. The greater the value of L the greater the secureness of the encryption.

For purposes of this description, one eight-bit unsigned integer uniform pseudorandom number generator will be referred to as A-PRNG, and the other eight bit unsigned integer uniform pseudorandom real number generator, as B-PRNG. A-PRNG and B-PRNG must be identical eight-bit unsigned integer uniform pseudorandom number generators. For purposes of this description, the algorithm will be described in the context of two endpoints communicating with each other, PNTA and PNTB. The algorithm description will refer to PRNG1 and PRNG2. PRNG1 and PRNG2 refer to either A-PRNG or B-PRNG as shown in Table 1 above.

The algorithm uses two other keys, KeyAA and KeyBB. KeyAA and KeyBB are bit strings (or equivalently, a number of bit length 2^{K}) each supplied as the seed to a uniform pseudorandom real number generator. For purposes of this embodiment, one uniform pseudorandom real number generator will be referred to as the AA-PRNG uniform pseudorandom real number generator, and the other as the BB-PRNG uniform pseudorandom real number generator. AA-PRNG is created using KeyAA as the seed. BB-PRNG is created using KeyBB as the seed. BB-PRNG and AA-PRNG use the identical random number generator. BB-PRNG and AA-PRNG generate a number in the range [0.0,MAX]. The value of MAX can be any positive real number. MAX=20.0 is suggested as sufficient. The lengths of KeyAA and KeyBB in bits are equal to 2K where K may be chosen as any integer greater than or equal to 4. The greater the value of K the greater the secureness of the encryption. KeyAA and KeyBB are initialized from successive values returned from PRNG1 and PRNG2, respectively.

A constant parameter is specified by the algorithm.

M=2^{(S-11)},

where S is the length of the cyclic redundancy check, CRC, in bits.

The algorithm employs a hashing function, HASH. The hashing algorithm is not dictated, but for example, SHA3-256 as defined in NIST publication SHA-3 Standard: Permutation-Based Hash and Extendable-Output Functions, FIPS 202, could be used. The input to HASH is a digest of variable length H bits. Suggested value of H is 256. HASH returns a hash value whose length in bits is equal to H.

Three variable parameters are initialized as follows:
1. CRC is initialized from successive values generated by PRNG1, the highest order byte assigned from the first value, the second highest order byte assigned from the second value, and so forth down to the lowest order byte.
2. DevSumThreshold is assigned by setting it equal to a value divided by M. The value is derived by computing the CRC of a hash value. The seed to the CRC computation is the CRC from the previous epoch (for first epoch, it is the initialized CRC). The hash value is the value returned by HASH. The input to HASH is equal to random byte values generated from PRNG1. If DevSumThreshold is less than MinThreshold, then DevSumThreshold is set to MinThreshold. Suggested value for MinThreshold is MAX.
3. DeviationSum is set to zero.

On the transmission side the bit stream is processed as follows:
a) RB number of random bytes are inserted into the bit stream preceding the beginning of the actual unencrypted data. RB is set equal to a single value generated by PRNG1. RB is in the range [0,255]. If RB is zero, then RB is set equal a default value. A default value of 20 is suggested. RB number of random bytes are then created using successive values generated from PRNG1.
b) The bit stream is shifted as described below in the function, SHIFTBITS.
   The bit stream is subsequently encrypted bit by bit as follows:
   1) A random number is generated by AA-PRNG, AA.
   2) A random number is generated by BB-PRNG, BB.

### 3) Calculate Deviation=AA−BB.

4) A running sum of the absolute value of the Deviation is maintained, DeviationSum.
5) A running sum of the number of bytes processed is maintained, ByteCnt.
6) If Deviation is greater than or equal to zero, then the next bit in the bit stream is inverted, otherwise it is not inverted. The resulting bit stream is the encrypted bit stream.
7) If DeviationSum is greater than DevSumThreshold, then a new epoch is begun and the following processing is performed, otherwise step 8 is performed next.
7a) DevSumThreshold is recomputed by setting it equal to a value divided by M. The value is derived by computing the CRC of a hash value. The seed to the CRC computation is the CRC of the previous epoch. The hash value is the value returned by HASH. The input to HASH is filled with random byte values generated from PRNG1. If DevSumThreshold is less than MinThreshold, then DevSumThreshold is set to MinThreshold. Suggested value for MinThreshold is MAX.
7b) The existing AA-PRNG is destroyed, and a new AA-PRNG is created with bit string seed equal to a value returned from HASH. The input to HASH is equal to a bit string completely filled with random values generated from PRNG1.
7c) The existing BB-PRNG is destroyed, and a new BB-PRNG is created with bit string seed equal to a value returned from HASH. The input to HASH is equal to a bit string completely filled with random values generated from PRNG2.
7d) DeviationSum is reset to zero.
   8) The algorithm is repeated from step 1 until all bits have been processed.

The encrypted data stream may then be transmitted to the receiving endpoint, such as depicted endpoint 104. In the depicted embodiment, this is shown at 1000B. On the receiving side the bit stream is processed bit by bit and decrypted as follows:

0) The number of prepended random bytes, RB, is set equal to a random value returned from PRNG1 after which PRNG1 is called RB number of times. If RB was zero, then RB was set equal to the default value.
1) A random number is generated by AA-PRNG, AA.
2) A random number is generated by BB-PRNG, BB.

### 3) Calculate Deviation=AA−BB.

4) A running sum of the absolute value of the Deviation is maintained, DeviationSum.
5) A running sum of the number of bytes processed is maintained, ByteCnt.
6) If Deviation is greater than or equal to zero, then the next bit in the bit stream is inverted, otherwise it is not inverted.
7) If DeviationSum is greater than DevSumThreshold, then a new epoch is begun and the following processing is performed, otherwise step 8 is performed next.
7a) DevSumThreshold is recomputed by setting it equal to a value divided by M. The value is derived by computing the CRC of a hash value. The seed to the CRC computation is the CRC of the previous epoch. The hash value is the value returned by HASH. The input to HASH is filled with random byte values generated from PRNG1. If DevSumThreshold is less than MinThreshold, then DevSumThreshold is set to MinThreshold. Suggested value for MinThreshold is MAX.
7b) The existing AA-PRNG is destroyed, and a new AA-PRNG is created with bit string seed equal to a value returned from HASH. The input to HASH is equal to a bit string completely filled with random values generated from PRNG1.
7c) The existing BB-PRNG is destroyed, and a new BB-PRNG is created with bit string seed equal to a value returned from HASH. The input to HASH is equal to a bit string completely filled with random values generated from PRNG2.
7d) DeviationSum is reset to zero.
   8) The algorithm is repeated from step 1 until all bits have been processed.
   9) The bit stream is unshifted as described below in the function, UNSHIFTBITS. The resulting bit stream is the decrypted bit stream. The decrypted bit stream is identical to the original unecrypted bit stream.
   10) The first RB number of bytes are discarded from the bit stream, thus removing the prepended random bytes and leaving only the unencrypted actual data.

Function SHIFTBITS treats the bit stream as a set of shift registers, S[i]. The size of the ith shift register, SS[i], and the bit shift of the ith shift register, SB[i], are random values. Starting with index i=0, the process of forming the shift registers and performing the bit shifting is as follows:
1) SS[i] is set equal to a return value of PRNG1. SB[i] is set equal to a return value of PRNG1. If SB[i] is greater than SS[i], then their values are interchanged, that is, SB[i]=SS[i] and SS[i]=SB[i].
(2) If BC+SS[i], where BC is a running total of the number of bits processed, is greater than the total number of bits, TB, in the bit stream, then SS[i] is adjusted by setting it equal to TB−BC. If SB[i] is now greater than or equal to SS[i], then SB[i] is scaled by the ratio of the adjusted SS[i] divided by the original SS[i].
(3) In the ith register, S[i], bit 0 is shifted forward SB[i] number of bits, bit 1 is shifted forward SB[i] number of bits, bit 2 is shifted forward SB[i] number of bits, and so forth until SS[i] number of bits are processed. For bits shifted past the end of S[i], they are wrapped around starting at the first bit of S[i].
(4) A running count of the number of bits processed is maintained, BC=BC+SS[i]. When BC>=TB, then SHIFTBITS is exited.
(5) The index i is incremented by 1 and processing continues at step 1.

Function UNSHIFTBITS is the antithesis of SHIFTBITS. Starting with the index i=0, the process of undoing the bit shifting performed by SHIFTBITS is as follows:
1) SS[i] is set equal to a return value of PRNG1. SB[i] is set equal to a return value of PRNG1. If SB[i] is greater than SS[i], then their values are interchanged, that is, SB[i]=SS[i] and SS[i]=SB[i].
(2) If BC+SS[i], where BC is a running total of the number of bits processed, is greater than the total number of bits, TB, in the bit stream, then SS[i] is adjusted by setting it equal to TB−BC. If SB[i] is now greater than or equal to SS[i], then SB[i] is scaled by the ratio of the adjusted SS[i] divided by the original SS[i].
(3) In the ith register, S[i], bit 0 is shifted backward SB[i] number of bits, bit 1 is shifted backward SB[i] number of bits, bit 2 is shifted backward SB[i] number of bits, and so forth until SS[i] number of bits are processed. For bits shifted backward past the beginning of S[i], they are wrapped around starting at the last bit of S[i].
(4) A running count of the number of bits processed is maintained, BC=BC+SS[i]. When BC>=TB, then UNSHIFTBITS is exited.
(5) The index i is incremented by 1 and processing continues at step 1.

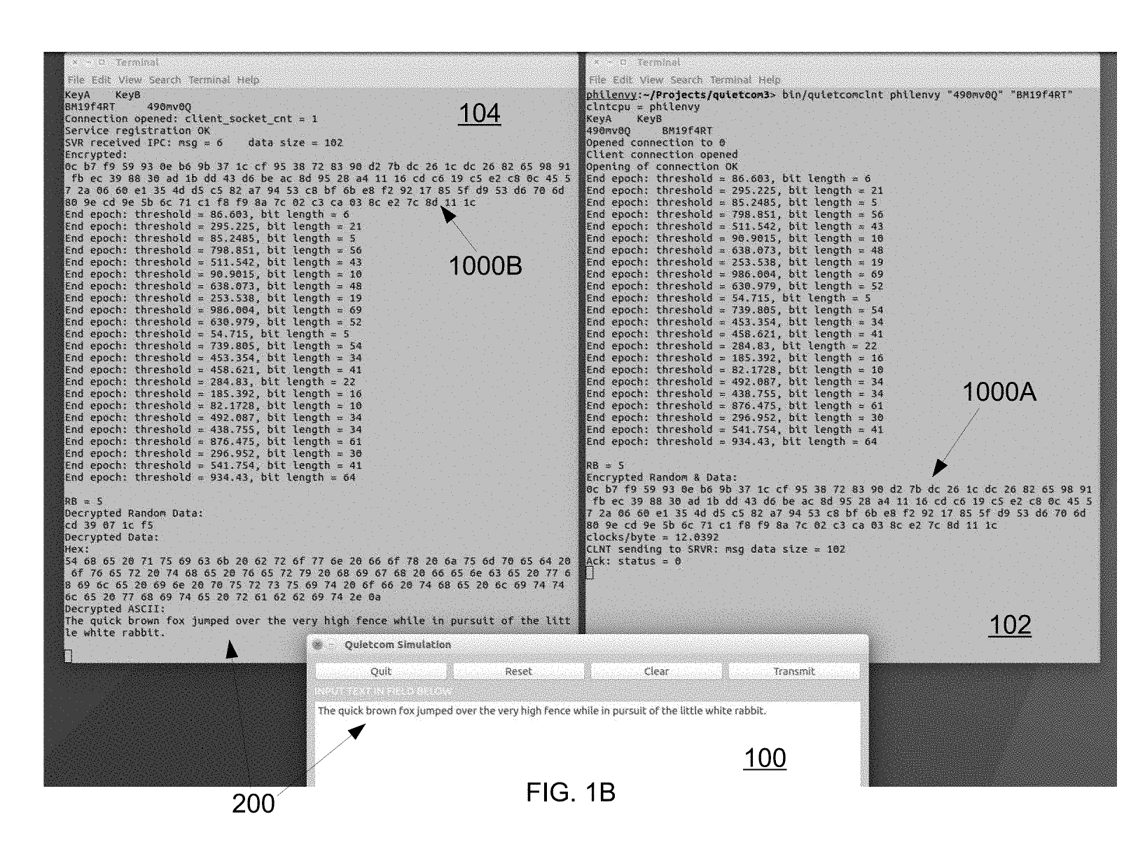

FIG. 2 provides a schematic diagram of an example networked or distributed computing environment. The distributed computing environment comprises computing objects 510, 512, etc., and computing objects or devices 520, 522, 524, 526, 528, etc., which may include programs, methods, data stores, programmable logic, etc. as represented by example applications 530, 532, 534, 536, 538. It can be appreciated that computing objects 510, 512, etc. and computing objects or devices 520, 522, 524, 526, 528, etc. may comprise different devices, such as personal digital assistants (PDAs), audio/video devices, mobile phones, MP3 players, personal computers, laptops, etc. Each of these computing objects or devices may serve as an endpoint for the use methods disclosed herein.

Each computing object 510, 512, etc. and computing objects or devices 520, 522, 524, 526, 528, etc. can communicate with one or more other computing objects 510, 512, etc. and computing objects or devices 520, 522, 524, 526, 528, etc. by way of the communications network 540, either directly or indirectly. Even though illustrated as a single element in FIG. 2, communications network 540 may comprise other computing objects and computing devices that provide services to the system of FIG. 2, and/or may represent multiple interconnected networks, which are not shown. Each computing object 510, 512, etc. or computing object or device 520, 522, 524, 526, 528, etc. can also contain an application, such as applications 530, 532, 534, 536, 538, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used. For example, communications made incident to the systems as described in various embodiments.

Thus, a host of network topologies and network infrastructures, such as client/server, peer-to-peer, or hybrid architectures, can be utilized.

In a client/server architecture, particularly a networked system, a client is usually a computer that accesses shared network resources provided by another computer, e.g., a server. In the illustration of FIG. 5, as a non-limiting example, computing objects or devices 520, 522, 524, 526, 528, etc. can be thought of as clients and computing objects 510, 512, etc. can be thought of as servers where computing objects 510, 512, etc., acting as servers providing data services, such as receiving data from client computing objects or devices 520, 522, 524, 526, 528, etc., storing of data, processing of data, transmitting data to client computing objects or devices 520, 522, 524, 526, 528, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 540 or bus is the Internet, for example, the computing objects 510, 512, etc. can be Web servers with which other computing objects or devices 520, 522, 524, 526, 528, etc. communicate via any of a number of known protocols, such as the hypertext transfer protocol (HTTP). Computing objects 510, 512, etc. acting as servers may also serve as clients, e.g., computing objects or devices 520, 522, 524, 526, 528, etc., as may be characteristic of a distributed computing environment.

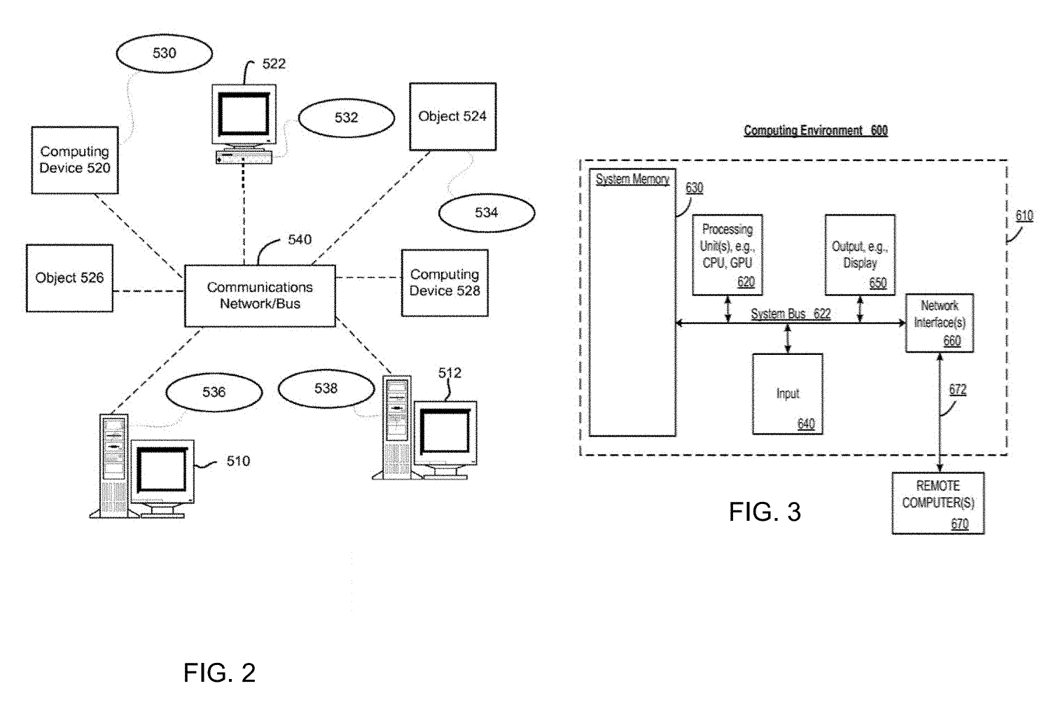

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 3 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 3 thus illustrates an example of a suitable computing system environment 600 in which one or aspects of the embodiments described herein can be implemented, although as made clear above, the computing system environment 600 is only one example of a suitable computing environment and is not intended to suggest any limitation as to scope of use or functionality. In addition, the computing system environment 600 is not intended to be interpreted as having any dependency relating to any one or combination of components illustrated in the example computing system environment 600.

With reference to FIG. 3, an example remote device for implementing one or more embodiments includes a general purpose computing device in the form of a computer 610. Components of computer 610 may include, but are not limited to, a processing unit 620, a system memory 630, and a system bus 622 that couples various system components including the system memory to the processing unit 620.

Computer 610 typically includes a variety of computer readable media and can be any available media that can be accessed by computer 610. The system memory 630 may include computer storage media in the form of volatile and/or nonvolatile memory such as read only memory (ROM) and/or random access memory (RAM). By way of example, and not limitation, system memory 630 may also include an operating system, application programs, other program modules, and program data.

A user can enter commands and information into the computer 610 through input devices 640. A monitor or other type of display device is also connected to the system bus 622 via an interface, such as output interface 650. In addition to a monitor, computers can also include other peripheral output devices such as speakers and a printer, which may be connected through output interface 650.

The computer 610 may operate in a networked or distributed environment using logical connections to one or more other remote computers, such as remote computer 670. The remote computer 670 may be a personal computer, a server, a router, a network PC, a peer device or other common network node, or any other remote media consumption or transmission device, and may include any or all of the elements described above relative to the computer 610. The logical connections depicted in FIG. 6 include a network 672, such local area network (LAN) or a wide area network (WAN), but may also include other networks/buses. Such networking environments are commonplace in homes, offices, enterprise-wide computer networks, intranets and the Internet.

As mentioned above, while example embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

While this disclosure has been described using certain embodiments, it can be further modified while keeping within its spirit and scope. This application is therefore intended to cover any variations, uses, or adaptations of the disclosure using its general principles. Further, this application is intended to cover such departures from the present disclosure as come within known or customary practices in the art to which it pertains and which fall within the limits of the appended claims.

What is claimed is:

1. A computer implemented method for conducting encrypted communications over a computer network, comprising:
receiving a first bit stream for a communication in a first computer memory;
encrypting the first bit stream beginning at the first bit thereof using at least a first processor by
generating a first random number by supplying a first unsigned integer number as a first key to a first uniform pseudorandom number generator,
generating a second random number by supplying a second unsigned integer number which differs from the first unsigned integer number as a second key to a second uniform pseudorandom number generator,
calculating a first Deviation between the first random number and the second random number, and where the first Deviation is greater than or to equal zero, inverting next bit in the first bit stream to generate an encrypted bit stream;
transmitting the encrypted bit stream from the first computer memory over a computer network.

2. The computer implemented method of claim 1, further comprising, dividing the first bit stream into a set of shift registers with the number of shift registers randomly determined before encrypting the first bit stream.

3. The computer implemented method of claim 2, wherein dividing the first bit stream into a set of shift registers with the number of shift registers randomly determined comprises dividing the first bit stream into a set of shift registers where within each register the size of the shift is randomly determined and the subsequent implementation of the bit shifting within each shift register is randomly determined.

4. The computer implemented method of claim 1, wherein the first uniform pseudorandom number generator is a uniform pseudorandom real number generator.

5. The computer implemented method of claim 1, wherein the first uniform pseudorandom number generator is a uniform pseudorandom unsigned 8-bit integer generator.

6. The computer implemented method of claim 1, further comprising calculating a running sum of the absolute value of the difference of the first random number and the second random number and comparing the running sum to a first random threshold, and when the running sum exceeds the first random threshold, generating a first randomly generated seed value and a second randomly generated seed value and using the first randomly generated seed value and the second randomly generated seed value as the first key and the second key for the subsequent bit in the first bit stream.

7. The computer implemented method of claim 6, further comprising calculating an initial value for the first random threshold as half the maximum value of the range of the first uniform pseudorandom number generator multiplied by a first set value.

8. The computer implemented method of claim 7, further comprising that when the running sum exceeds the first random threshold, a new value for the first random threshold is recomputed as the first randomly generated seed value divided by 2^{(bit size cyclic redundancy check-11)}.

9. The computer implemented method for claim 1, further comprising
receiving the transmitted encrypted bit stream in a second computer memory;
decrypting the encrypted bit stream beginning at the first bit thereof using at least a second processor by
generating a third random number by supplying the first unsigned integer number as a first key to a third uniform pseudorandom number generator,
generating a fourth random number by supplying the second unsigned integer number which differs from the third unsigned integer number as a second key to a fourth uniform pseudorandom number generator,
calculating a second Deviation between the third random number and the fourth random number, and where second Deviation is greater than or to equal zero, inverting next bit in the encrypted bit stream to generate a decrypted bit stream, which is identical to the first bit stream.

10. The computer implemented method of claim 9, wherein the third uniform pseudorandom number generator is a uniform pseudorandom real number generator.

11. The computer implemented method of claim 9, wherein the fourth uniform pseudorandom number generator is a uniform pseudorandom unsigned 8-bit integer number generator.

12. The computer implemented method of claim 9, further comprising calculating a running sum of the absolute value of the difference of the third random number and the fourth random number and comparing the running sum to a second random threshold, and when the running sum exceeds the second random threshold, generating a third randomly generated seed value and a fourth randomly generated seed value and using the third randomly generated seed value and the fourth randomly generated seed value as the first key and the second key for the subsequent bit in the encrypted bit stream.

13. The computer implemented method of claim 12, further comprising calculating an initial value for the second random threshold as half the maximum value of the range of the first uniform pseudorandom number generator multiplied by a first set value.

14. The computer implemented method of claim 13, further comprising that when the running sum exceeds the second random threshold, a new value for the second random threshold is recomputed as the first randomly generated seed value divided by 2^{(bit size cyclic redundancy check-11)}.

15. A non-transitory storage medium having stored therein computer-executable instructions which, when executed by one or more hardware processors, implement and/or cause the implementation of one or more of the processes of claim 1.

16. A system, comprising:
a computing device including one or more hardware processors;
a non-transitory storage medium having stored therein computer-executable instructions which, when executed by the one or more hardware processors encrypts a first bit stream received by the system beginning at the first bit thereof by
generating a first random number by supplying a first unsigned integer number as a first key to a first uniform pseudorandom number generator,
generating a second random number by supplying a second unsigned integer number which differs from the first unsigned integer number as a second key to a second uniform pseudorandom number generator,
calculating a first Deviation between the first random number and the second random number, and where the first Deviation is greater than or to equal zero, inverting next bit in the first bit stream to generate an encrypted bit stream;
transmitting the encrypted bit stream from the first computer memory over a computer network.

17. The system of claim 16, wherein the system is operable to divide the first bit stream into a set of shift registers prior to encryption, with the number of shift registers randomly determined and where within each register the size of the shift is randomly determined and the subsequent implementation of the bit shifting within each shift register is randomly determined.

18. The system of claim 16, wherein the system is operable to calculate a running sum of the absolute value of the difference of the first random number and the second random number and compare the running sum to a first random threshold, and when the running sum exceeds the first random threshold, generate a first randomly generated seed value and a second randomly generated seed value and use the first randomly generated seed value and the second randomly generated seed value as the first key and the second key for the subsequent bit in the first bit stream.

19. The system of claim 18, wherein the system is operable to calculate an initial value for the first random threshold as half the maximum value of the range of the first uniform pseudorandom number generator multiplied by a first set value.

20. The system of claim 19, wherein the system is operable such that when the running sum exceeds the first random threshold, a new value for the first random threshold is recomputed as the first randomly generated seed value divided by 2^{(bit size cyclic redundancy check-11)}.
